(19) United States
(12) Patent Application Publication
(10) Pub. No.: US 2022/0229635 A1
(43) Pub. Date: Jul. 21, 2022

(54) ENVIRONMENT CONSTRUCTION SUPPORT SYSTEM, APPARATUS, ENVIRONMENT CONSTRUCTION SUPPORT METHOD, AND PROGRAM

(71) Applicant: NEC Corporation, Minato-ku, Tokyo (JP)

(72) Inventors: Ryosuke OHARA, Tokyo (JP); Yujin YOKOGAWA, Tokyo (JP)

(73) Assignee: NEC Corporation, Minato-ku, Tokyo (JP)

(21) Appl. No.: 17/609,162

(22) PCT Filed: May 1, 2020
(86) PCT No.: PCT/JP2020/018438

§ 371 Date: Nov. 5, 2021

(30) Foreign Application Priority Data
May 10, 2019 (JP) 2019-090057

(51) Int. Cl. G06F 8/20; G06F 8/60; G06F 9/455; G06F 9/50

(52) U.S. Cl. CPC G06F 8/20; G06F 9/5005; G06F 9/455; G06F 8/60

(57) ABSTRACT

An environment construction support system includes a know-how accumulation unit that accumulates in a storage apparatus, know-how information about environment construction for an image that is a source of a container, and an environment construction support unit that on reception of an environment construction request with fragmentary environment construction information from a request source, acquires know-how information from the know-how accumulation unit, complements the fragmentary environment construction information, based on the know-how information to generate completed environment construction information.

### TECHNICAL FIELD

### Reference to Related Application

The present invention is based upon and claims the benefit of the priority of Japanese patent application No. 2019-090057 filed on May 10, 2019, the disclosure of which is incorporated herein in its entirety by reference thereto. The present invention relates to an environment construction support system, apparatus, an environment construction support method, and program.

### BACKGROUND

In recent years, virtualization technology is attracting attention in order to flexibly and quickly respond to change in a market environment. In hypervisor-based server virtualization technology, a guest OS (Operating System) and an application are installed on a virtual machine (Virtual Machine) which runs on a hypervisor. On the other hand, container-based virtualization technology provides multiple virtual user spaces, called containers, on an OS, and an application runs in the container, as illustrated schematically in FIG. 14. A container engine provides a container execution environment. Container-based virtualization technology does not require configuration and invocation of a guest OS. The container-based virtualization technology has the following features:

Lighter than hypervisor-based virtualization technology;

High speed in launching and application; and so forth.

For more information on container-based virtualization technology, reference will be made to, for example, PTL (Patent Literature) 2.

The following describes, as a premise for understanding the following example embodiments, etc., an outline of container-based virtualization technology using Docker as an example (regarding Docker, reference mat be made to, for example, NPL (Non-Patent Literature) 1). A Docker engine (corresponding to a container engine in FIG. 14) operates and manages a Docker container (corresponding to a container in FIG. 14) running on a host machine. A Docker image is a file of image of the operating system, middleware, etc. (binaries/libraries (corresponding to Bins/Libs in FIG. 14)) from which a Docker container is created. The Docker image is read-only and includes stacked image layers. A Docker container is a container that runs as a process on the host machine's operating system, with an additional writable container layer. Docker Hub is a public repository that is available to anyone and provides a service that allows anyone to obtain Docker images. A Dockerfile is a template (a text file, also called an orchestration template) that provides an instruction and setting for installing a Docker image or Docker container.

Docker, for example, has the following features.

It can be run anywhere by simply downloading a Docker image on ae machine where Docker is implemented.

It has a public repository (Docker Hub) that anyone can use, and many Docker images are available to public. By using them, there is no need to create a system from scratch, which is more efficient.

In order to increase portability, Docker images provide functionality on per service unit in detail. Therefore, it is common to use a combination of multiple Docker images.

FIG. 15 is a diagram illustrating schematically an example of constructing each component of OpenStack using Docker containers (see NPL (Non-Patent Literature) 2, etc.). In FIG. 15, an orchestrator (not shown) obtains (pulls) multiple Docker images corresponding to each of the multiple components of OpenStack from Docker Hub and deploys the multiple Docker images as containers on host machines (Node #1 and #2). Note that in FIG. 15, Horizon provides a web GUI (Graphical User Interface) for OpenStack. Keystone is responsible for user authentication when accessing OpenStack dashboard screens and/or API (Application Programming Interface). Nova-api receives a request to Nova from an end user. MariaDB is an opensource relational database system.

Regarding a related technology for automatic resource construction, PTL (Patent Literature) 1 discloses a system that can automatically construct a technology hierarchy (combination of physical machines, virtual machines, operating systems, etc.) that satisfies a fuzzy (ambiguous) resource request entered by a user. In order to automatically construct resources using multiple managed physical machines that contain resources, classes of elements that make up the resources, information corresponding to elements that make up the resources, and knowledge for constructing elements corresponding to instances are provided. When a resource request is entered, the request is decomposed into conditions including class hierarchy, a selection condition(s), and an exclusion condition(s). If an instance that satisfies the specified conditions can be retrieved, the instance is output as a resource that satisfies the user's request.

Regarding cloud orchestration, PTL 2 discloses a method for automated application deployment, wherein the method is performed by a cloud management node. The cloud management node is deployed in at least one of a plurality of computing apparatuses. The method includes: a step of receiving an application orchestration template to be entered by a user; a step of analyzing an application model characteristic of the application from the application orchestration template; a step of determining a first instance creation method corresponding to the application according to the application model characteristic and a predetermined rule; a step of determining a first computer apparatus corresponding to the first instance creation method among the plurality of computer apparatuses; and a step of sending a first instance creation command to the first computer apparatus, wherein the first instance creation command is used to instruct the first computer apparatus to create the first instance for the application according to the first instance creation method.

Regarding automation of virtualization environment construction, PTL 3 discloses a virtualization environment construction support system including: a database server that stores construction information of a virtualization environment constructed in the past for constructing a computer virtualization environment; a data warehouse server that stores a standard virtualization environment construction information for constructing a new computer virtualization environment; a business logic server that generates a scrip, which is a simple program for constructing a virtualized environment; wherein the business logic server generates a script to construct a new virtualized environment in a virtual computer system that satisfies user conditions based on the virtualized environment construction condition set by the user, obtains from the database server actual virtualization environment construction information that is similar to hardware and resource information set by the user, and obtains standard virtualized environment construction information from the data warehouse server, and generates a script to generate the virtualized environment construction information to newly construct a virtualized environment in the virtual computer system that conforms to the hardware and resource information used by the user, based on the obtained actual virtualized environment construction information and the standard virtualized environment construction information.

### CITATION LIST

### Patent Literature

[Patent Literature 1] Japanese Patent Kokai Publication No. 2009-245409
[Patent Literature 2] Japanese Patent Kohyo Publication No. 2019-503535
[Patent Literature 3] Japanese Patent Kokai Publication No. 2011-242964

### Non-Patent Literature

[Non-Patent Literature 1] [Illustration] Understanding the whole picture of Docker−Part 1, viewed on Apr. 10, 2018, Internet (URL: https://qiita.com/kotaro-dr/items/b1024c7d200a75b992fc)
[Non-Patent Literature 2] About OpenStack Kolla viewed Apr. 23, 2017, Internet (URL: https://www.business-on-it.com/2004-kolla/)

### SUMMARY

### Technical Problem

In the related container-based virtualization technology (Docker as an example), there is a function to package a file system on a container or virtual machine as an image. Using this function, a system to share developed images among unspecified number of image development administrator is provided (Docker Hub as an example).

In general, there are multiple Docker image developers/managers and multiple service developers/managers, and they work independently. As a result, it is difficult to share information among them, and the Docker image development administrator is basically unable to understand details of the Docker image other than the one the development administrator has developed. As a result, there is a possibility that multiple Docker images developed by different Docker image developers/managers and uploaded onto the Docker Hub are not suitable for concomitant use.

In addition, there is no way (means) for other service development administrator to utilize know-how information that one service development administrator has about an image, such as configuration, version number, performance, etc. As a result, the other service development administrator may have to design from scratch, even if the image has been already constructed in other environments.

As package management systems of related technologies that resolve package dependencies, yum (Yellowdog Updater Modified) and apt (Advanced Packaging Tool) are known. However, there are multiple patterns of configurations using a specific Docker image, and the Docker image development administrator cannot uniquely determine a configuration. For this reason, it is difficult to solve the above issues with package management systems of related technologies such as yum and apt.

In the above described PTL 1, a resource request is taken as an input, and if an instance satisfying a predetermined condition can be retrieved, that instance is output as a resource that satisfies the user's request, which does not address the above issue(s).

The present invention has been invented in view of the above issues. One of the objectives of the present invention is to provide an environment construction support system, apparatus, method, and program, each enabling use of know-how information on image, for environment construction, the know-how information not known by a requester making an environment construction request.

### Solution to Problem

According to one aspect of the present invention, there is provided an environment construction support system including: a know-how accumulation unit that accumulates in a storage apparatus, know-how information about environment construction for an image that is a source of a container; and an environment construction support unit that on reception of an environment construction request with fragmentary environment construction information from a request source, acquires know-how information from the know-how accumulation unit, and complements, based on the know-how information, the fragmentary environment construction information to generate completed environment construction information.

According to another aspect of the present invention, there is provided an environment construction support method including:

on reception of an environment construction request with fragmentary environment construction information from a request source,

acquiring know-how information from a know-how accumulation unit that accumulates know-how information about environment construction for an image that is a source of a container; and

complementing, based on the know-how information, the fragmentary environment construction information to generate completed environment construction information.

According to another aspect of the present invention, there is provided an environment construction support apparatus including: a means that, on reception of an environment construction request with the fragmentary environment construction information is received from a request source, transmits a know-how information request to a know-how accumulation unit that accumulates know-how information about environment construction for an image that is a source of a container, in order to acquire know-how information for complementing the fragmentary environment construction information; and a means that, on reception of the know-how information that matches the fragmentary environment construction information in response to the know-how information request, complements, based on the know-how information, the fragmentary environment construction information to generate completed environment construction information.

According to a yet another aspect of the present invention, there is provided a program causing a processor to perform processing including:

on reception of an environment construction request with the fragmentary environment construction information from a request source, transmitting a know-how information request to a know-how accumulation unit that accumulates know-how information about environment construction for an image that is a source of a container, in order to acquire know-how information for complementing fragmentary environment construction information; and

on reception of the know-how information that matches the fragmentary environment construction information in response to the know-how information request, complementing the fragmentary environment construction information, based on the know-how information to generate completed environment construction information.

According to yet another aspect of the present invention, a computer readable recording medium recorded thereon the above program (e.g., RAM (Random Access Memory), ROM (Read Only Memory), EEPROM (Electrically Erasable and Programmable ROM)) and other semiconductor storage apparatuses such as HDD (Hard Disk Drive), SSD (Solid State Drive), CD (Compact Disc), DVD (Digital Versatile (Digital Versatile Disc, etc.) will be provided.

### Advantageous Effects of Invention

According to the present invention, know-how information about image(s) which is not known by a requester that makes an environment construction request can be used for environment construction.

### BRIEF DESCRIPTION OF DRAWINGS

FIGS. 1A and 1B are diagrams illustrating management of Docker images (comparative example).

FIGS. 2A and 2B are diagrams illustrating management of Docker images (comparative example).

FIGS. 3A and 3B are diagrams illustrating management of Docker images (comparative example).

FIG. 4 is a diagram illustrating an example embodiment of a system of the present invention.

FIG. 5 is a diagram illustrating schematically an example embodiment of the present invention.

FIG. 6 is a diagram illustrating schematically an example embodiment of the present invention.

FIG. 7 is a diagram illustrating know-how accumulation information of a know-how accumulation unit of an example embodiment of the present invention.

FIG. 8 is a diagram illustrating an example of a configuration of a know-how accumulation unit of an example embodiment of the present invention.

FIG. 9 is a diagram illustrating an example of a configuration of an environment construction support unit of an example embodiment of the present invention.

FIG. 10 is a flowchart describing a procedure for pre-registration of know-how information in an example embodiment of the present invention.

FIGS. 11A and 11B are flowcharts illustrating a procedure for pre-registering images and constructing infrastructure in advance in an example embodiment of the present invention, respectively.

FIG. 12 is a flowchart illustrating a procedure in an example embodiment of the present invention.

FIG. 13 is a flowchart illustrating an example of a computer implementation of an example embodiment of the present invention.

FIG. 14 is a diagram illustrating container-based virtualization technology.

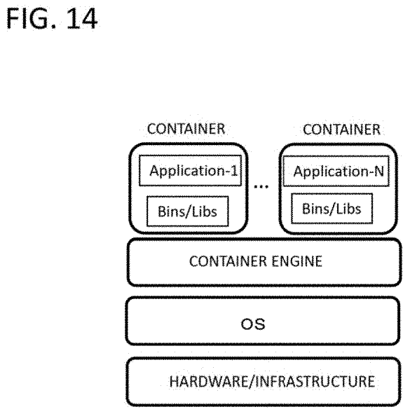

FIG. 15 is a diagram illustrating schematically an example of cloud orchestration.

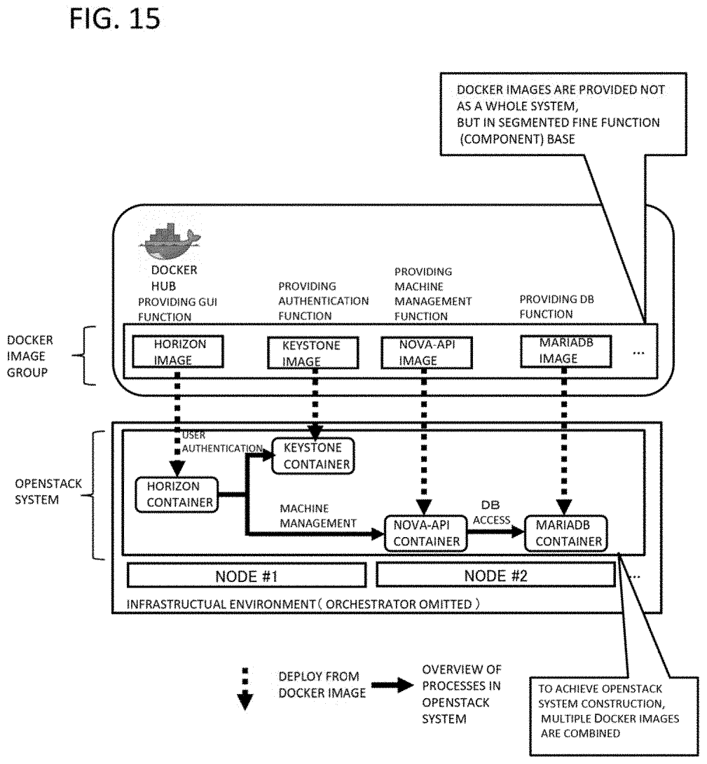

### DESCRIPTION OF EMBODIMENTS

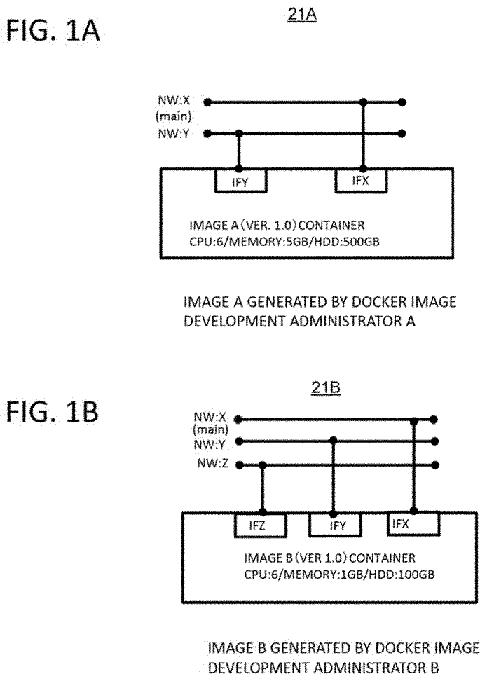

First, a comparative example of Docker image management without implementation of the present invention is described. FIGS. 1A and 1B are diagrams illustrating an example in which the combined use (sharing) of images A and B developed by Docker image development administrator A and B respectively (also referred to simply as “image(s)”) and registered in Docker Hub is not suitable. FIGS. 1A and 1B schematically illustrate a configuration of an image that is a source of a container. In configuration 21A in FIG. 1A, a version number of image A is 1.0, and resources allocated to the image A include two networks (NW), NW:X and NW: Y, six-core CPUs (Central Processing Units), a memory capacity of 5 GB (Giga Bytes), and an HDD (Hard Disk Drive) capacity: 500 GB. IFX and IFY are NICs (Network Interface Cards) that connect to NW: X and NW: Y, respectively.

In configuration 21B in FIG. 1B, a version number of image B is 1.0, and resources allocated to the image B are: three networks (NW), NW:X, NW: Y, and NW: Z, six-core CPUs, memory capacity: 1 GB, HDD capacity: 100 GB. IFZ is NIC that connects to NW: Z.

Image A and Image B do not coincide with respect to a network used. Also, both image A and image B require a large amount of the same resources (CPUs). In addition, Image A and Image B use NW:X as their main network (main). Therefore, running applications in containers corresponding to image A and image B will not give desired performance. In this way, a Docker image development administrator basically cannot grasp details of images other than those developed by the development administrator. As a result, as mentioned above, there are cases where the use of Image: A and Image: B developed by different Docker image developers/managers, A and B, respectively, is not suitable.

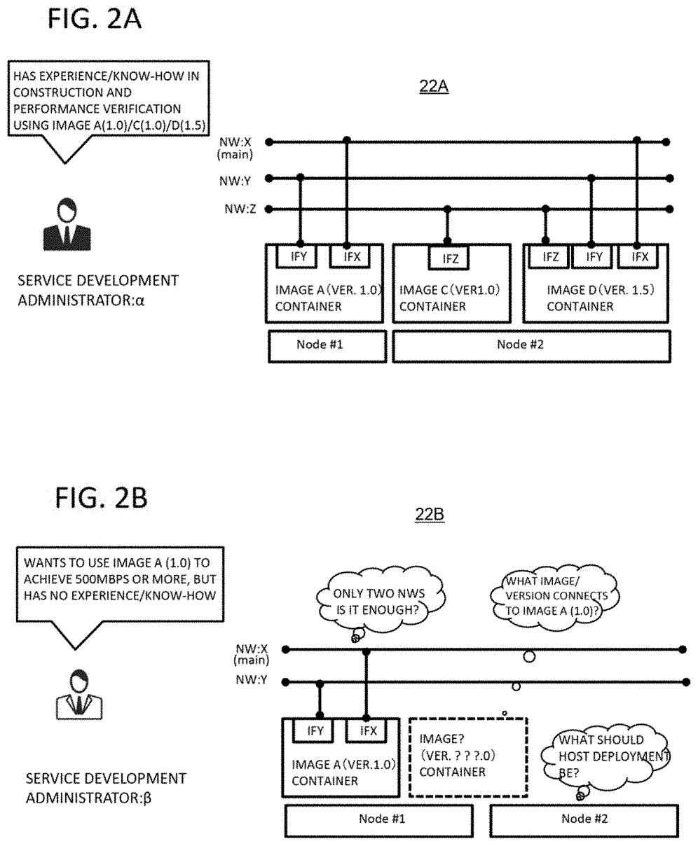

FIGS. 2A and 2B are diagrams illustrating an example where there are multiple service development administrators, but the know-how information of image construction, version number, performance, etc. grasped by one service development administrator is not utilized by another service development administrator. FIGS. 2A and 2B schematically illustrate information on original images of containers.

In configuration 22A in FIG. 2A, service development administrator: a has an experience (track record) and know-how of constructing a system using images A (1.0), C (1.0), and D (1.5) and verifying performance of the system. In FIG. 2A, a version 1.0 of image A is deployed on Node #1, and a version 1.0 of image C and a version 1.5 of image D are deployed on Node #2. In FIG. 2A, the service development administrator: a has already constructed a system using images A (1.0), C (1.0), and D (1.5), and has the experience and know-how to verify (confirm) its performance.

In the configuration 22B in FIG. 2B, a service development administrator: β wants to use image A (1.0) and achieve a communication speed of 500 Mbps (megabits per second), but has no experience or know-how. For example,

Is it enough to have two networks, NW:X and NW:Y?

What is the image and a version thereof connected to image A (1.0)?, and

What host should the container be deployed?

Thus, the service development administrator (β) has no way to utilize the know-how information that the service development administrator (α) has about the configuration, number of versions, performance, host deployment, etc., and thus may have to start designing an environment from scratch.

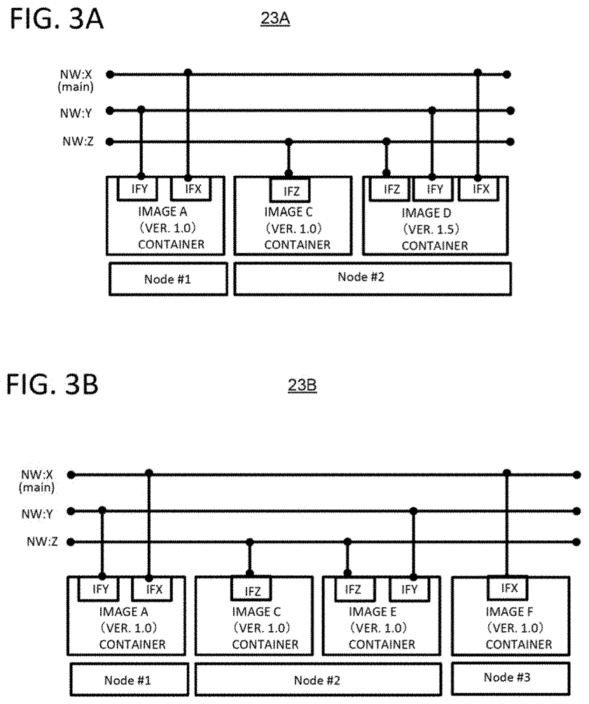

FIGS. 3A and 3B are diagrams illustrating an example of multiple configurations using Docker images. There are multiple patterns of configurations using image A (1.0), as shown in FIGS. 3A and 3B as configurations (1) and (2). Configuration 23A in FIG. 3A is identical to configuration 22A in FIG. 2A. Configuration 23B in FIG. 3B differs from the configuration in FIG. 3A in the placement of the container on Node #2 (where the container for image E (1.0) is placed), and also adds Node #3, which deploys the container for image F (1.5). There may not be a case that the development administrator of a Docker image cannot uniquely decide whether to adopt configuration 23A or configuration 23B.

In contrast to the comparative examples described above, the present invention provides at least a system, apparatus, method, and program, each enabling to use in environment construction of know-how information about images that is not grasped, for example, by a service development administrator who makes an environment construction request. The following describes example embodiments of the present invention. An example embodiment of the present invention accumulates and collects configuration, version number, and performance information obtained by a service development administrator(s) and a know-how information provider as know-how information, while maintaining independence of each worker, and enables other service development administrators to effectively utilize such information. As a result, the system supports the construction of environment(s) by a service development administrator or the like to reduce a workload thereof.

According to an example embodiment of the present invention, a know-how accumulation unit (know-how storage apparatus, know-how accumulation mechanism) is provided to accumulate unique know-how information such as the configuration, version number, and performance information of a Docker image (abbreviated as “image”) obtained by, for example, a service development administrator(s) (e.g., a Docker image user) or a know-how provider(s). The know-how information can then be used by other service development administrator through the environment construction support unit (environment construction support apparatus, environment construction support mechanism).

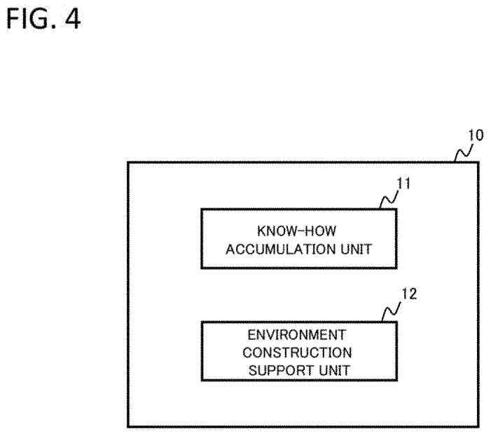

FIG. 4 is a diagram illustrating an example embodiment of the present invention. Referring to FIG. 4, a know-how accumulation unit (mechanism, apparatus) 11 and an environment construction support unit (mechanism, apparatus) 12 are provided. The know-how accumulation unit 11 and the environment construction support unit 12 constitute an environment construction support apparatus 10.

The know-how accumulation unit 11 accumulates know-how information on environment construction for an image that is a source of a container in a storage apparatus (not shown).

On reception of a request from a requester (e.g., a service development administrator) to construct an environment with fragmentary environment construction information that includes items that are unspecified or not completed because the requester does not grasp the configuration, the environment construction support unit 12 obtains necessary know-how information from the know-how accumulation unit 11, and completes the fragmentary environment construction information based on the know-how information to generate completed environment construction information.

In an example embodiment, on reception of fragmentary environment construction information, the environment construction support unit 12 sends a know-how information request to the know-how accumulation unit 11 in order to obtain know-how information that complements the fragmentary environment construction information.

On reception of a know-how information request from the environment construction support unit 12, the know-how accumulation unit 11 searches whether know-how information matching the fragmentary environment construction information is registered in a storage apparatus (not shown), and if so, sends the corresponding know-how information to the environment construction support unit 12.

Based on the know-how information transmitted from the know-how accumulation unit 11, the environment construction support unit 12 complements the fragmentary environment construction information to generate the completed environment construction information.

In an example embodiment, the environment construction support unit 12 may request the know-how accumulation unit 11 to search for know-how information registered in a storage apparatus that partially matches fragmentary environment construction information, if know-how information about images that matches the fragmentary environment construction information is not available in the know-how accumulation unit 11.

The environment construction support unit 12 may transmit partially matched know-how information to a requester of an environment construction request, when partially matched know-how information is returned from the know-how accumulation unit 11.

In an example embodiment, the fragmentary environment construction information may be configured to have priority information that specifies which item of know-how information is to be prioritized. When a plurality of matched items of the above mentioned know-how information is registered in the know-how accumulation unit 11, the environment construction support unit 12 may be configured to select one of the plurality of items of the know-how information provided by the know-how accumulation unit 11 based on the priority information.

In an example embodiment, a service development administrator can enter the fragmentary environment construction information, for example, as environment construction information (a template (text file) describing image(s) making up the environment, a deployment target of the image(s), etc.) for constructing the environment from a terminal or the like connected to the environment construction support unit 12 simply by inputting the information, can generate completed environment construction information by complementing information from the know-how information accumulated in the know-how accumulation unit 11. The completed environment construction information is passed to an orchestrator. The orchestrator acquires a corresponding image from a public repository in which images are accumulated, according to the environment construction information, and deploys the image on a host based on the environment construction information. The environment construction support unit 12 may be configured as a software module.

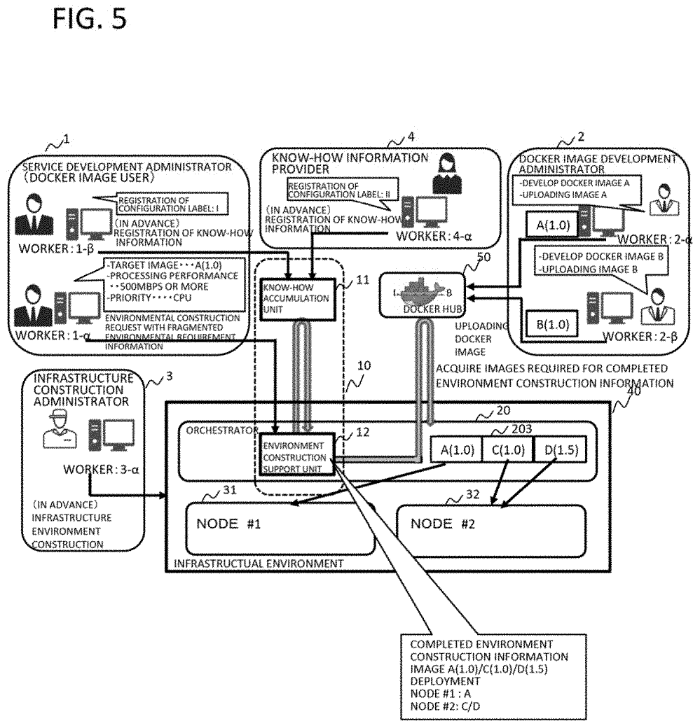

FIG. 5 is a diagram illustrating an example embodiment of the present invention. In FIG. 5, Docker Hub 50 is a registry in which Docker images are laid open. Docker Hub 50 accumulates Docker images developed by Docker image development administrator 2 and provides a Docker image(s) in response to a request from Orchestrator 20.

An infrastructure environment 40 represents a server environment or network environment constructed by an infrastructure construction administrator 3. As an non-limiting example, FIG. 5 illustrates an example in which the infrastructure environment 40 includes an orchestrator 20 and physical machines (hosts) 31 and 32 on which containers are deployed.

The orchestrator 20 acquires a Docker image from Docker Hub 50 according to environment construction information and performs deployment of a container. The reference number 203 designate the Docker image obtained by the orchestrator 20 from Docker Hub 50. The Docker image 203 is used as a container to a host, in deployment performed by the orchestrator 20.

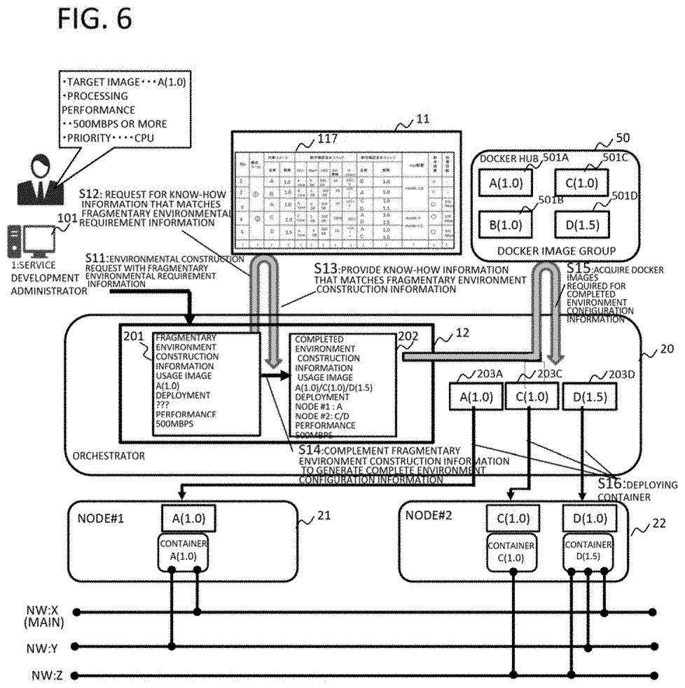

Service development administrator 1 (worker: 1-β) registers know-how information to the know-how accumulation unit 11 in advance (registers configuration label I in FIG. 6, which will be described later). Know-how information provider 4 (worker: 4-α) registers know-how information to the know-how accumulation unit 11 in advance (registers configuration label II in FIG. 6 to be described later).

Docker image development administrator 2 develops images A (1.0) and B (1.0), and workers (2-α, 2-β) upload (push) images A (1.0) and B (1.0) to Docker Hub 50, respectively.

An infrastructure construction administrator 3 (worker: 3-α) constructs infrastructure environment 40 (server environment, network environment, etc.) in advance.

FIG. 5 illustrates an example of a case where a service development administrator 1 (operator: 1-α) makes an environment construction request specifying following information as fragmentary environment construction information:

target image: A (1.0);

processing performance: 500 Mbps or more; and

priority: CPU priority,

and normal processing is performed.

The service development administrator 1, for example, enters an environment construction request with fragmentary environment construction information into the environment construction support unit 12 from a terminal of the service development administrator 1.

On reception of the environment construction request, the environment construction support unit 12 requests know-how information that matches the fragmentary environment construction information from the know-how accumulation unit 11.

On reception of a request for know-how information, the know-how accumulation unit 11 provides know-how information that matches the fragmentary environment construction information to the environment construction support unit 12.

The environment construction support unit 12 uses the obtained know-how information to create completed environment construction information as follows:

Image: A (1.0)/C (1.0)/D (1.5); and

Deployment Node #1: A, and
Node #2: C/D;
   and pass the created environment construction information to the orchestrator 20.

The orchestrator 20 retrieves Docker images A (1.0), C (1.0), and D (1.5) from a Docker Hub 50, based on the completed environment construction information.

The orchestrator 20 deploys image A (1.0) on Node #1 as container: A (1.0) and images C (1.0) and D (1.5) on Node #2 as containers: C (1.0) and D (1.5, respectively, in accordance with the host deployment specified in the completed environment construction information.

FIG. 6 is a diagram illustrating in more detail of an example embodiment described with reference to FIG. 5. The following describes with reference to FIG. 6, an example case where a service development administrator specifies target image: A (1.0) and processing performance: 500 Mbps or higher as fragmentary environment construction information and successfully processes it (a case where the know-how accumulation unit 11 is able to find know-how information that matches the fragmentary environment construction information).

First, the service development administrator 1 supplies an environment construction request with fragmentary environment construction information into the environment construction support unit 12 from a terminal 101 (S11).

The environment construction support unit 12 stores the fragmentary environment construction information 201 in a storage apparatus (not shown). The fragmentary environment construction information 201 includes:

an image to be used: A (1.0);

deployment (host deployment): ???;

performance: 500 Mbps; and so forth.

In the fragmentary environment construction information 201, in the unspecified item “deployment (host deployment)”, the character string representing unspecified (inquiry): “???” is used as a reserved word, but a different character string may, as a matter of course, be used.

The environment construction support unit 12 requests the know-how accumulation unit 11 for know-how information that matches the fragmentary environment construction information (S12).

The know-how accumulation unit 11 provides know-how information that matches the fragmentary environment construction information to the environment construction support unit 12 (S13).

The environment construction support unit 12 generates completed environment construction information 202 by supplementing the fragmentary environment construction information with the obtained know-how information (S14). The environment construction support unit 12 stores the completed environment construction information 202 in an unshown storage apparatus.

In the example of FIG. 6, the completed environment construction information 202 is as follows

Image to be used: A (1.0)/C (1.0)/D (1.5);

Deployment (host deployment):

Node #1: A (1.0); and

Node #2: C (1.0)/D (1.5);

Performance: 500 Mbps.

In the completed environment construction information 202, “A(1.0)” in the fragmentary environment construction information 201 is complemented and modified to “A(1.0)/C(1.0)/D(1.5)” and in the fragmentary environment construction information 201, information of unspecified deployment (host deployment): “Node #1: A (1.0)” and “Node #2: C (1.0)/D (1.5)” are newly filled in.

The environment construction support unit 12 passes the completed environment construction information 202 to the orchestrator 20. The environment construction support unit 12 may send the completed environment construction information 202 to the terminal 101 of the service development administrator 1, which is the requester of the environment construction request, and cause the terminal 101 to present the completed environment construction information 202 on a display screen or the like of the terminal 101.

The orchestrator 20 acquires Docker image(s) required for the completed environment construction information 202 from Docker Hub 50 (S15).

The orchestrator 20 performs deployment of the Docker image acquired to a host in accordance with the environment construction information (S16).

The orchestrator 20 deploys Image: A (1.0) (container) on node #1 (31), and Image: C (1.0) and D (1.5) (containers) on node #2 (32). It is noted that in node #1 (31), container A (1.0) is connected to network (NW): X and Y, and in node #2 (32), container C (1.0) is connected to network (NW): Z, and container D (1.5) is connected to network (NW): X, Y, and Z.

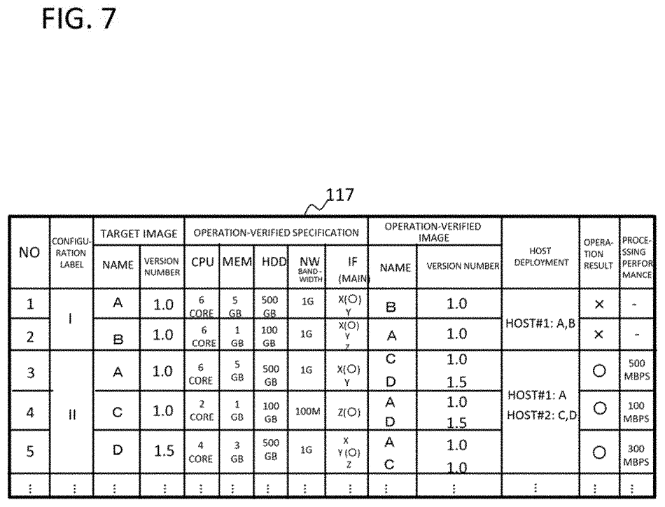

FIG. 7 is a diagram illustrating schematically data structure of the know-how information 117 accumulated by the know-how accumulation unit 11 in FIG. 6. In FIG. 7, a configuration whose operation was verified corresponds to one configuration label (in FIG. 7, configuration label-I and configuration label-II). For each image included in the configuration is provided in an individual separate line, and resources allocated to the image are placed in “Specification with operation checked”. For each of the configuration labels (I and II), the know-how information 117 includes the following information:

Target image (name, version number);

As the verified specifications, the CPU (number of CPU cores), Mem (memory) capacity, HDD (Hard Disk Drive) capacity, network bandwidth, and interface (IF) assigned to the target image (X (0) indicates that it is an interface that communicates and connects with NW: X);

Image operation-confirmed (name, version number) (name and version number of one or more images that have been operation-confirmed in a configuration combined with the target image, e.g., in entry No. 3, images C (1.0) and D (1.5) have been operation-confirmed for target image A, and the operation result is Okay);

Host deployment (the host where the target image is deployed as a container);

Operation result (circle: operation result is obtained, and the result is Okay, x: operation result is not obtained, or the result is not Okay); and

Processing performance (such as the communication speed of the image whose operation has been confirmed).

Information to be registered as know-how information 117 can be added or deleted as necessary. The know-how information 117 is not limited to a format shown in FIG. 7. The know-how accumulation unit 11 may use a database to manage tables of know-how information 117. In this case, the know-how accumulation unit 11 may be configured to access the database via a communication means instead of having the database internally.

The fragmentary environment construction information is part of the environment construction information that is known by the service development administrator 1 and the following two pieces of information (target image and processing performance) are mandatory specified parameters, and parameters that are specified optionally can be added as necessary.

For example, as accumulation of know-how progresses, a case can be assumed in which there are multiple pieces of know-how information that match conditions. In this case, it is possible to specify which one should be given priority.

Target Image: Name and version number of the image with functionality that a service development administrator wants to use.

Processing performance: Processing performance expected by service development administrator.

Priority: A parameter that the service development administrator wants to prioritize when multiple know-how information exists. In the fragmentary environment construction information 201 in FIG. 6, the priority is given to CPU.

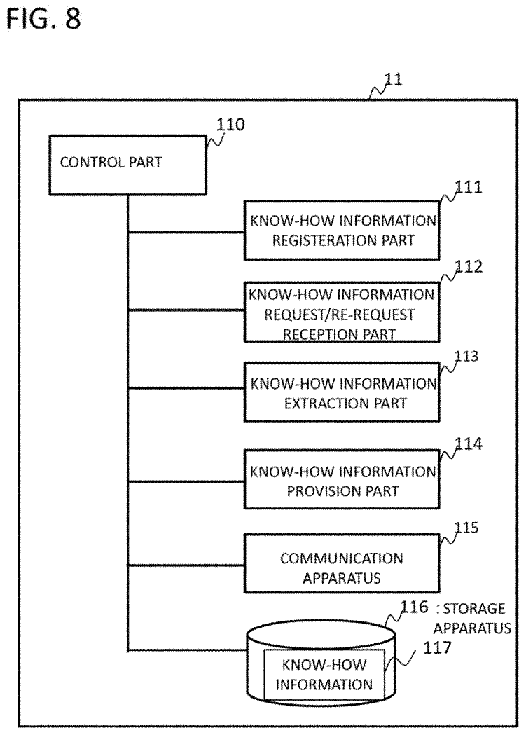

FIG. 8 is a diagram illustrating a configuration (function) of the know-how accumulation unit 11 in an example embodiment of the present invention. Referring to FIG. 8, in the know-how accumulation unit 11, the know-how information registration part 111 registers the know-how information 117 transmitted from a terminal of the service development administrator 1 or the know-how information provider 4 in a storage apparatus 116. A know-how information request/re-request reception unit 112 receives a know-how information request/re-request sent from the environment construction support unit 12.

A know-how information extraction unit 113 searches the know-how information 117 registered in the storage apparatus 116 based on the know-how information request/re-request received by the know-how information request/re-request reception part 112, and extracts the know-how information that matches the fragmentary environment construction request information (know-how information that complements the fragmentary environment construction information).

The know-how information extraction part 113 extracts know-how information that matches the fragmentary environment construction request information (know-how information that complements the fragmentary environment construction information). Also, the know-how information extraction part 113 searches the know-how information 117 stored in the storage apparatus 116 based on the know-how information request/re-request received by the know-how information request/re-request reception part 112 to extract the know-how information that partially matches the fragmentary environment construction request information (know-how information that partially complements the fragmentary environment construction information).

A know-how information provision part 114 returns the know-how information extracted by the know-how information extraction part 113 to the environment construction support unit 12 via the communication apparatus 115 as a response.

A communication apparatus 115 communicatively connects with terminals of the service development administrator 1 or the know-how information provider 4 and the environment construction support unit 12.

A control unit 110 controls each part in the know-how accumulation unit 11. Function of each part in the know-how accumulation unit 11 may be implemented by a program executed by a computer. The storage apparatus 116 may be provided outside the know-how accumulation unit 11 and accessed via a communication apparatus 115 or the like.

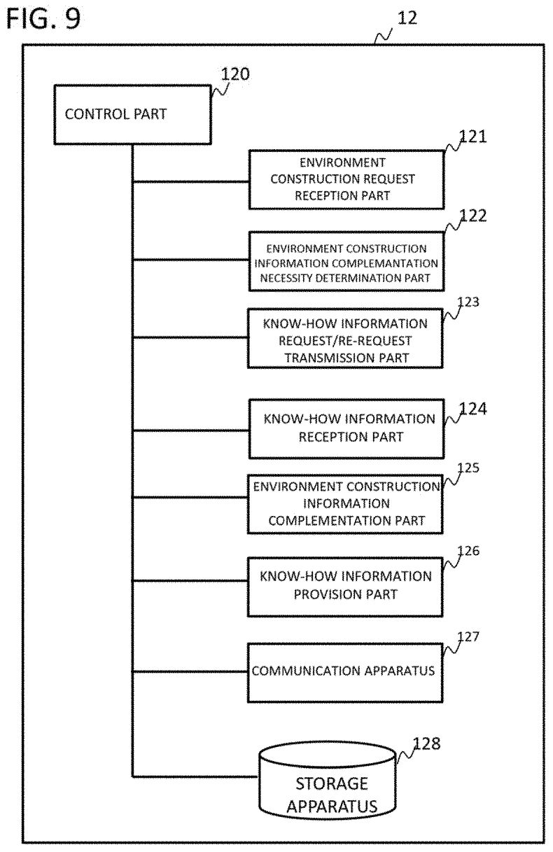

FIG. 9 is a diagram illustrating a configuration (functions) of the environment construction support unit 12. Referring to FIG. 9, in the environment construction support unit 12, an environment construction request reception part 121 receives an environment construction request sent from a terminal 101 of a service development administrator 1 via a communication apparatus 127.

An environment construction information complementation necessity determination part 122 determines whether or not the environment construction information included in the environment construction request is fragmented and needs to be complemented. If the environment construction information complementation necessity determination part 122 determines that the environment construction information is complete (no need to complement), the environment construction information sent from the terminal 101 of the service development administrator 1 is passed to the orchestrator 20 as it is.

If the environment construction information is determined by the environment construction information complementation necessity determination part 122 to be fragmented and needs to be supplemented, a know-how information request/re-request transmission unit 123 transmits a request for know-how information to the know-how accumulation unit 11 via the communication apparatus 127.

A know-how information reception part 124 receives the know-how information returned from the know-how accumulation unit 11 via a communication apparatus 127.

An environment construction information complementation part 125 generates completed environment construction information, by using the know-how information (by complementing the fragmentary environment construction information based on the know-how information), when the know-how information matching the fragmentary environment construction information (know-how information that complements the fragmented environment construction information) is transmitted from the know-how accumulation unit 11.

In the environment construction information complementation part 125, when know-how information matching the fragmentary environment construction information is not transmitted from the know-how accumulation unit 11, the environment construction information complementation part 125 does not generate completed environment construction information, but transmits a know-how information re-request from the know-how information request/re-request transmission part 123 to the know-how accumulation unit 11 via the communication apparatus 127.

In the know-how information reception part 124, when know-how information that partially matches the fragmentary environment construction information is received from the know-how accumulation unit 11 via the communication apparatus 127 as a response to the know-how information a re-request, the know-how information provision part 126 transmits the partially matched know-how information to a terminal 101 of service development administrator 1.

The communication apparatus 127 communicates and connects with the terminal 101 of the service development administrator 1 and the know-how accumulation unit 11.

The storage apparatus 128 stores fragmentary environment construction information 201, completed environment construction information 202, know-how information received from the know-how accumulation unit 11, and partially matched know-how information. The completed environment construction information 202 stored in the storage apparatus 128 is passed to the orchestrator 20. The completed environment construction information 202 stored in the storage apparatus 128 may be transmitted from the communication apparatus 127 to the terminal 101 of the service development administrator 1.

The control unit 120 controls processing of each part of the environment construction support unit 12. Function of each part of the environment construction support unit 12 may be implemented by a program executed by a computer. In the environment construction support unit 12, the communication apparatus 127 and the storage apparatus 128 may be provided in the environment construction support unit 12, or the communication apparatus and the storage apparatus of the infrastructure environment (40 in FIG. 5) in which the orchestrator 20 is installed may be used instead.

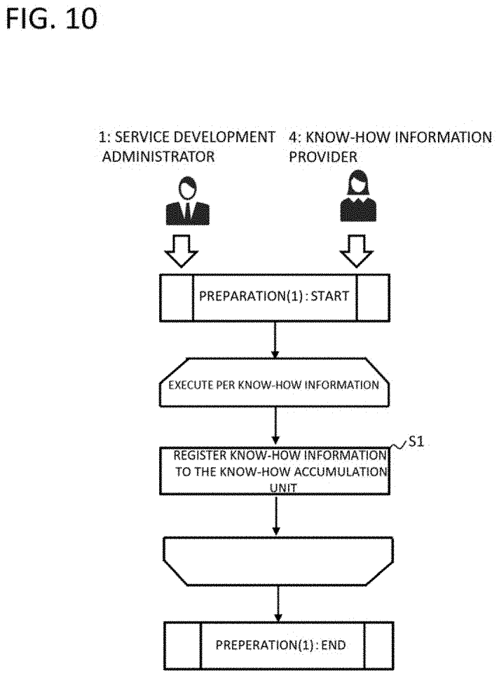

FIG. 10 is a flowchart illustrating a know-how information registration procedure of an example embodiment of the present invention. As a preliminary preparation (1), the service development administrator 1 and the know-how information provider 4 register know-how information to the know-how accumulation unit 11 for each know-how information. The service development administrator 1 and the know-how information provider 4 set and input information about the image, such as name, version number, resources, host deployment, operation result, and processing performance, as illustrated in the know-how information in FIG. 7, from a terminal (computer) connected to the know-how accumulation unit 11.

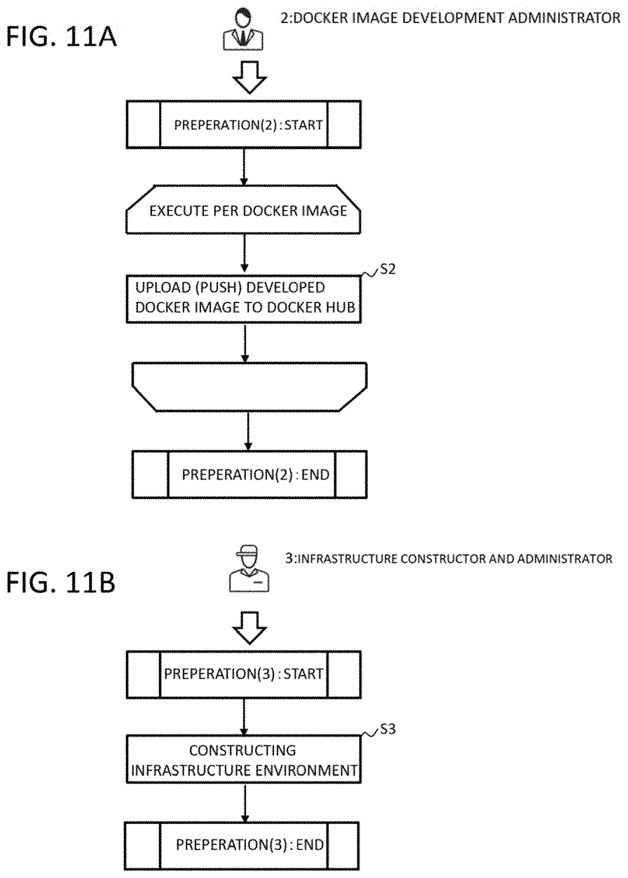

FIG. 11A is a flowchart illustrating an image registration procedure in an example embodiment of the present invention. Docker image development administrator 2 uploads (pushes) developed Docker image to Docker Hub, image by image, as a preliminary preparation (2) (S2).

FIG. 11B is a flowchart illustrating a procedure for constructing an infrastructure environment in an example embodiment of the present invention. An infrastructure construction administrator 3 constructs an infrastructure (infrastructure environment 40 in FIG. 5), such as a server and network environment, as a preliminary preparation (3).

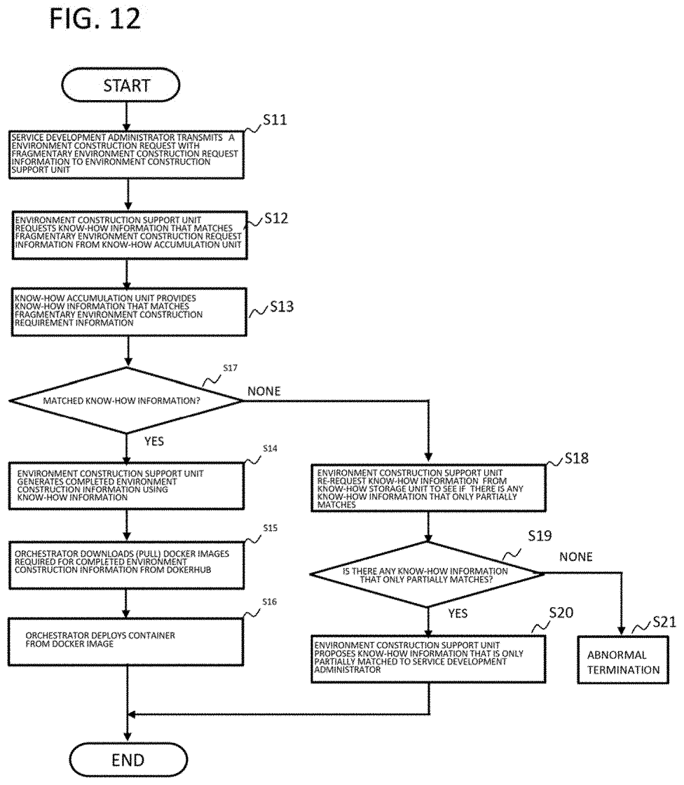

FIG. 12 is a flowchart illustrating a procedure for generating environment construction information in an example embodiment of the present invention. Steps S11 to S16 in FIG. 12 correspond to the steps S11 to S16 in FIG. 6.

The service development administrator 1 transmits an environment construction request with fragmentary information to the environment construction support unit 12 (S11).

The environment construction support unit 12 requests know-how information that matches the fragmentary environment construction information from the know-how accumulation unit 11 (S12). If the service development administrator 1 specifies, as fragmentary environment construction information 201, for example, target image: A (1.0), and processing performance: 500 Mbps or more, No. 3 in FIG. 7 is matched, and the know-how information of configuration label II (image to be used: A (1.0)/C (1.0)/D (1.5)) is matched. (1.5).

The know-how accumulation unit 11 provides know-how information that matches the fragmentary environment construction information to the environment construction support unit 12 (S13).

The environment construction support unit 12, when know-how information that matches the fragmentary environment construction information is returned from the know-how accumulation unit 11 (branch of “Yes” in S17), complements the fragmentary environment construction information, based on the returned know-how information to generate the completed environment construction information (S14).

The orchestrator 20 acquires (download: pull) Docker image(s) required for the completed environment construction information from Docker Hub 50 (S15).

The orchestrator 20 deploys a container from the acquired Docker image on the host machine (S16).

The environment construction support unit 12, when no matching know-how information is returned from the know-how accumulation unit 11 (branch of “none” in S17), re-requests know-how information from the know-how accumulation unit 11 to see if there is any know-how information that only partially matches the fragmented environment construction information (S18).

The environment construction support unit 12, when know-how information that only partially matches the fragmentary environment construction information is returned from the know-how accumulation unit 11 (branch of “Yes” in S19), sends (proposes) the returned know-how information that only partially matches to the terminal 101 of the service development administrator 1 (S20). In this case, based on the know-how information that only partially matches the fragmentary environment construction information, there is a possibility that the service development administrator will switch over to a different configuration that the service development administrator was not able to grasp.

The environment construction support unit 12, when there is no know-how information that only partially matches the fragmented environment construction information (know-how information that only partially matches the fragmented environment construction information is not returned from the know-how accumulation unit 11) (branch of “none” in S19), for example, terminates abnormally (returns an error) (S21). Alternatively, the environment construction support unit 12 may send a message to the terminal 101 of the service development administrator 1 that no know-how information matching the fragmented environment construction information has been registered.

According to the present example embodiment, the service development administrator 1 only needs to design parts that are to be used by the service development administrator 1, and the other parts can be automatically supplemented by the environment construction support unit 12 with the know-how information of other personnel to generate the completed environment construction information, which makes it possible to facilitate environment construction and expect workload reduction.

The know-how accumulation unit 11 provides know-how information matching fragmentary environment construction information to the environment construction support unit 12. However, when there are multiple items of know-how information matching the fragmentary environment construction information, the environment construction support unit 12 may sort the fragmentary environment construction information by priority parameter to select items of the know-how information with the highest priority, when the priority parameter is specified in the fragmentary environment construction information. When there is more than one item (piece) of know-how information whose superiority and inferiority cannot be determined, the environment construction support unit 12 may return a response to that effect to the terminal of the service development administrator 1, requesting for addition of specification of a priority parameter.

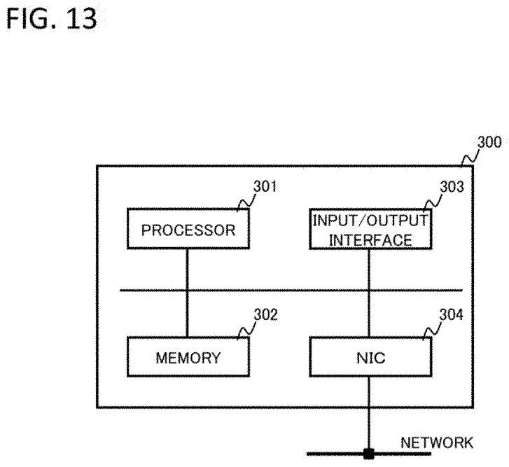

FIG. 13 is a diagram illustrating a configuration in which the know-how accumulation unit 11 and the environment construction support unit 12 are implemented in a computer 300 such as a server. Referring to FIG. 13, the computer 300 includes a processor 301, memory 302 such as semiconductor memory such as RAM (Random Access Memory), ROM (Read Only Memory), EEPROM (Electrically Erasable Programmable Read-Only memory 302, such as semiconductor memory such as RAM (Random Access Memory), ROM (Read Only Memory), EEPROM (Electrically Erasable Programmable Read-Only Memory), etc., an input/output interface 303 for accessing input/output apparatuses (such as a display apparatus, printer, and auxiliary storage apparatuses such as a hard disk), and a NIC (Network Interface Card) 304 for connecting to a network. By executing a program stored in the memory 302, the know-how accumulation unit 11 or the environment construction support unit 12 can be realized. The know-how accumulation unit 11 and the environment construction support unit 12 may be implemented on separate computers or on a single computer apparatus. For example, they can be implemented on virtual machines and communicate with each other via a virtual network. In this case, the storage apparatus of the know-how accumulation unit 11 may be implemented as a virtual storage. Furthermore, the environment construction support unit 12 may be implemented in such a way that it is apparently embedded in the orchestrator 20 when viewed from the terminal 101 of the service development administrator 1. In this case, an environment construction request from the terminal 101 of the service development administrator 1 may be transmitted to the orchestrator 20, and when the orchestrator 20 detects an input of the environment construction request, it may pass it on to the environment construction support unit 12.

Note that each disclosure of Patent Literatures 1-3 and Non-Patent Literatures 1,2 are incorporated herein in its entirety by reference thereto, and may be used as a basis or part of the present invention as necessary. It is possible to modify and adjust the example embodiments or examples within the whole disclosure of the invention (including the claims) and based on the basic technical concept thereof. Further, it is possible to variously combine or select a wide variety of disclosed elements (including the individual elements of the individual claims, the individual elements of the example embodiments or examples, and the individual elements of the individual figures) within the scope of the disclosure of the present invention. That is, it is self-explanatory that the present invention includes any types of variations and modifications to be done by a skilled person according to the whole disclosure including the Claims, and the technical concept of the present invention.

The above described embodiments are described as following Supplementary notes (Notes), though not limited thereto.

### [Note 1]

The environment construction support system, including:

a know-how accumulation unit that accumulates in a storage apparatus, know-how information about environment construction for an image that is a source of a container; and

an environment construction support unit that on reception of an environment construction request with fragmentary environment construction information from a request source, acquires know-how information from the know-how accumulation unit, complements the fragmentary environment construction information, based on the know-how information to generate completed environment construction information.

### [Note 2]

The environment construction support system according to Note1, wherein the environment construction support unit includes

a means that on reception of the fragmentary environment construction information, transmits a know-how information request to the know-how accumulation unit, in order to acquire know-how information to complement the fragmentary environment construction information, wherein

the know how accumulation unit includes

a means that on reception of the know-how information request from the environment construction support unit, searches to find whether or not the know-how information that matches the fragmentary environment construction information is registered in the storage apparatus, and transmits the know-how information to the environment construction support unit, in a case where the know how information that matches the fragmentary environment construction information is registered, and wherein

the environment construction support unit further includes

a means that on reception of the know-how information transmitted from the know-how accumulation unit, complements the fragmentary environment construction information to generate the completed environment construction information, based on the know-how information received.

### [Note 3]

The environment construction support system according to Note 1 or 2, wherein the environment construction support unit includes:

a means that requests the know-how accumulation unit to search to find whether or not know-how information that matches partially the fragmentary environment construction information is stored in the storage apparatus, when know-how information regarding image that matches the fragmentary environment construction information is not acquired; and

a means that transmits the know-how information that partially matches the fragmentary environment construction information to a source of the environment construction request, when the know-how information that partially matches the fragmentary environment construction information is returned from the know-how accumulation unit.

### [Note 4]

The environment construction support system according to any one of Notes 1 to 3, wherein the fragmentary environment construction information includes

priority information that specifies which item is prioritized among the know-how information, and wherein

the environment construction support unit includes

a means that selects any one from a plurality of items of the know-how information returned from the know-how accumulation unit, based on the priority information, in case where in the know-how accumulation unit has the plurality of items of the know-how information that match the fragmentary environment construction information registered in the storage apparatus.

### [Note 5]

The environment construction support system according to Note 4, wherein the environment construction support unit includes

a means that requests the request source to add priority information, when the environment construction support unit cannot determine superiority or inferiority of the know-how information based on the priority information of the fragmentary environment construction information.

### [Note 6]

The environment construction support system according to any one of Notes 1 to 5, wherein the know-how information registered in the storage apparatus provided in the know-how accumulation unit includes, for a target individual image, at least any one of:

a version number of the target image;

configuration and specification of one or more resources assigned to the target image;

an image and a version number thereof, operation confirmed with a configuration combined with the target image;

a host with the target image deployed thereon; and

performance of processing of the target image.

### [Note 7]

The environment construction support system according to any one of Notes 1 to 6, wherein the environment construction support unit delivers the completed environment construction information to an orchestrator, acquires corresponding image(s) from public repository that accumulate image(s) according to the environment construction information, and deploys the image(s) to a host as a container.

### [Note 8]

An environment construction support method, including:

on reception of an environment construction request with fragmentary environment construction information from a request source,

acquiring know-how information from a know-how accumulation unit that accumulates know-how information about environment construction for an image that is a source of a container; and

complementing the fragmentary environment construction information, based on the know-how information to generate completed environment construction information.

### [Note 9]

The environment construction support method according to Note 8, including:

on reception of the fragmentary environment construction information, transmitting a know-how information request to the know-how accumulation unit, in order to acquire know-how information to complement the fragmentary environment construction information,

on reception of the know-how information request, the know how accumulation unit searching to find whether or not the know-how information that matches the fragmentary environment construction information is registered in the storage apparatus,

receiving the know-how information from the know how accumulation unit, in a case where the know how information that matches the fragmentary environment construction information is registered, and wherein

complementing the fragmentary environment construction information to generate the completed environment construction information, based on the know-how information received.

### [Note 10]

The environment construction support method according to Note 8 or 9, including:

requesting the know-how accumulation unit to search to find whether or not know-how information that matches partially the fragmentary environment construction information is stored in the storage apparatus, when know-how information regarding image that matches the fragmentary environment construction information is not acquired; and

transmitting the know-how information that partially matches the fragmentary environment construction information to a source of the environment construction request, when the know-how information that partially matches the fragmentary environment construction information is returned from the know-how accumulation unit.

### [Note 11]

The environment construction support method according to any one of Notes 8 to 10, wherein the fragmentary environment construction information includes

priority information that specifies which item is prioritized among the know-how information, and wherein the method includes

selecting any one from a plurality of items of the know-how information returned from the know-how accumulation unit, based on the priority information, in case where in the know-how accumulation unit has the plurality of items of the know-how information that match the fragmentary environment construction information registered in the storage apparatus.

### [Note 12]

The environment construction support method according to Note 11, including:

requesting the request source to add priority information, when the environment construction support unit cannot determine superiority or inferiority of the know-how information based on the priority information of the fragmentary environment construction information.

### [Note 13]

The environment construction support method according to any one of Notes 8 to 12, wherein the know-how information registered in the storage apparatus provided in the know-how accumulation unit includes, for a target individual image, at least any one of:

a version number of the target image;

configuration and specification of one or more resources assigned to the target image;

an image and a version number thereof, operation confirmed with a configuration combined with the target image;

a host with the target image deployed thereon; and

performance of processing of the target image.

### [Note 14]

The environment construction support method according to any one of Notes 8 to 13, including:

delivering the completed environment construction information to an orchestrator;

acquiring corresponding image(s) from public repository that accumulate image(s) according to the environment construction information; and

deploying the image(s) to a host as a container.

### [Note 15]

The environment construction support apparatus including:

a means that, on reception of an environment construction request with the fragmentary environment construction information is received from a request source, transmits a know-how information request to a know-how accumulation unit that accumulates know-how information about environment construction for an image that is a source of a container, in order to acquire know-how information for complementing the fragmentary environment construction information; and

a means that, on reception of the know-how information that matches the fragmentary environment construction information in response to the know-how information request, complements the fragmentary environment construction information, based on the know-how information to generate completed environment construction information.

### [Note 16]

The environment construction support apparatus according to Note 15, includes

a means that on reception of the fragmentary environment construction information, transmits a know-how information request to the know-how accumulation unit, in order to acquire know-how information to complement the fragmentary environment construction information, wherein the know how accumulation unit, on reception of the know-how information request from the environment construction support unit, searches to find whether or not the know-how information that matches the fragmentary environment construction information is registered in the storage apparatus and

a means that receives the know-how information from the know-how accumulation unit, in a case where the know how information that matches the fragmentary environment construction information is registered; and

a means that on reception of the know-how information transmitted from the know-how accumulation unit, complements the fragmentary environment construction information to generate the completed environment construction information, based on the know-how information received.

### [Note 17]

The environment construction support apparatus according to Notes 15 or 16, includes

a means that requests the know-how accumulation unit to search to find whether or not know-how information that matches partially the fragmentary environment construction information is stored in the storage apparatus, when know-how information regarding image that matches the fragmentary environment construction information is not acquired; and

a means that transmits the know-how information that partially matches the fragmentary environment construction information to a source of the environment construction request, when the know-how information that partially matches the fragmentary environment construction information is returned from the know-how accumulation unit.

### [Note 18]

The environment construction support apparatus according to any one of Notes 15 to 17, wherein the fragmentary environment construction information includes

priority information that specifies which item is prioritized among the know-how information, and wherein

the environment construction support unit includes

a means that selects any one from a plurality of items of the know-how information returned from the know-how accumulation unit, based on the priority information, in case where in the know-how accumulation unit has the plurality of items of the know-how information that match the fragmentary environment construction information registered in the storage apparatus.

### [Note 19]

The environment construction support apparatus according to Notes 18, includes:

a means that requests the request source to add priority information, when the environment construction support unit cannot determine superiority or inferiority of the know-how information based on the priority information of the fragmentary environment construction information.

### [Note 20]

A program causing a processor to perform processing comprising:

on reception of an environment construction request with the fragmentary environment construction information from a request source, transmitting a know-how information request to a know-how accumulation unit that accumulates know-how information about environment construction for an image that is a source of a container, in order to acquire know-how information for complementing fragmentary environment construction information; and

on reception of the know-how information that matches the fragmentary environment construction information in response to the know-how information request, complementing the fragmentary environment construction information, based on the know-how information to generate completed environment construction information.

### [Note 21]

The program according to Note 20, causing the processor to perform processing comprising:

on reception of the fragmentary environment construction information, transmitting a know-how information request to the know-how accumulation unit, in order to acquire know-how information to complement the fragmentary environment construction information,

on reception of the know-how information request from the environment construction support unit, the know how accumulation unit searching to find whether or not the know-how information that matches the fragmentary environment construction information is registered in the storage apparatus,

receiving the know-how information from the know how accumulation unit, in a case where the know how information that matches the fragmentary environment construction information is registered, and wherein

complementing the fragmentary environment construction information to generate the completed environment construction information, based on the know-how information received.

### [Note 22]

The program according to Note 20 or 21, causing the processor to perform processing comprising:

requesting the know-how accumulation unit to search to find whether or not know-how information that matches partially the fragmentary environment construction information is stored in the storage apparatus, when know-how information regarding image that matches the fragmentary environment construction information is not acquired; and

transmitting the know-how information that partially matches the fragmentary environment construction information to a source of the environment construction request, when the know-how information that partially matches the fragmentary environment construction information is returned from the know-how accumulation unit.

### [Note 23]

The program according to any one of Notes 20 to 22, wherein the fragmentary environment construction information includes

priority information that specifies which item is prioritized among the know-how information, and wherein the processing includes

selecting any one from a plurality of items of the know-how information returned from the know-how accumulation unit, based on the priority information, in case where in the know-how accumulation unit has the plurality of items of the know-how information that match the fragmentary environment construction information registered in the storage apparatus.

### [Note 24]

The program according to any one of Notes 20 to 23, causing the processor to perform processing including:

requesting the request source to add priority information, when the environment construction support unit cannot determine superiority or inferiority of the know-how information based on the priority information of the fragmentary environment construction information.

### REFERENCE SIGNS LIST

1: service development administrator
2: docker image development administrator
3: infrastructure construction administrator
4: know-how information provider
10: environment construction support apparatus
11: know-how accumulation unit (know-how accumulation apparatus, know-how accumulation mechanics)
12: environment construction support unit (environment construction support apparatus, environment construction support unit)
20: orchestrator
21A,21B,22A,22B,23A,23B: image
31: host (host machine) (Node #1)
32: host (host machine) (Node #2)
40: infrastructural environment
50: Docker Hub
101: terminal
110: control unit
111: know-how information registration part
112: know-how information request/re-request reception part
113: know-how information extraction part
114: know-how information provision part
115: communication apparatus
116: storage apparatus
117: know-how information
120: control unit
121: environment construction request reception part
122: environment construction information complementation necessity determination part
123: know-how information request/re-request transmission part
124: know-how information reception part
125: environment construction information complementation part
126: know-how information provision part
127: communication apparatus
128: storage apparatus
201: fragmentary environment construction information
202: completed environment construction information
203A,203C,203D,501A,501B,501C,501D: image
300: computer
301: processor
302: memory
303: input/output interface
304: NIC

What is claimed is:

1. An environment construction support system comprising:
a know-how accumulation unit including
a first processor configured to accumulate in a storage apparatus, know-how information about environment construction for an image that is a source of a container; and
an environment construction support unit including
a second processor configured to:
on reception of an environment construction request with fragmentary environment construction information from a request source, acquire know-how information from the know-how accumulation unit; and
complement, based on the know-how information, the fragmentary environment construction information to generate completed environment construction information.

2. The environment construction support system according to claim 1, wherein the second processor included in the environment construction support unit is configured to
on reception of the fragmentary environment construction information, transmit a know-how information request to the know-how accumulation unit, in order to acquire know-how information to complement the fragmentary environment construction information, wherein
the first processor included in the know how accumulation unit is configured to:
on reception of the know-how information request from the environment construction support unit, search to find whether or not the know-how information that matches the fragmentary environment construction information is registered in the storage apparatus; and
transmit the know-how information to the environment construction support unit, in a case where the know how information that matches the fragmentary environment construction information is registered, and wherein
the second processor included in the environment construction support unit is further configured to
on reception of the know-how information transmitted from the know-how accumulation unit, complement the fragmentary environment construction information to generate the completed environment construction information, based on the know-how information received.

3. The environment construction support system according to claim 1, wherein the second processor included in the environment construction support unit is configured to:
request the know-how accumulation unit to search to find whether or not know-how information that matches partially the fragmentary environment construction information is stored in the storage apparatus, when know-how information regarding image that matches the fragmentary environment construction information is not acquired; and
transmit the know-how information that partially matches the fragmentary environment construction information to a source of the environment construction request, when the know-how information that partially matches the fragmentary environment construction information is returned from the know-how accumulation unit.

4. The environment construction support system according to claim 1, wherein the fragmentary environment construction information includes
priority information that specifies which item is prioritized among the know-how information, and wherein
the second processor included in the environment construction support unit is configured to
select any one from a plurality of items of the know-how information returned from the know-how accumulation unit, based on the priority information, in case where in the know-how accumulation unit has the plurality of items of the know-how information that match the fragmentary environment construction information registered in the storage apparatus.

5. The environment construction support system according to claim 4, wherein the second processor included in the environment construction support unit is configured to
request the request source to add priority information, when the environment construction support unit cannot determine superiority or inferiority of the know-how information based on the priority information of the fragmentary environment construction information.

6. The environment construction support system according to claim 1, wherein the know-how information registered in the storage apparatus provided in the know-how accumulation unit includes, for a target individual image, at least any one of:
a version number of the target image;
configuration and specification of one or more resources assigned to the target image;
an image and a version number thereof, operation confirmed with a configuration combined with the target image;
a host with the target image deployed thereon; and
performance of processing of the target image.

7. The environment construction support system according to claim 1, wherein the second processor included in the environment construction support unit is configured to
deliver the completed environment construction information to an orchestrator, and wherein
the orchestrator acquires a corresponding image from public repository that accumulate images according to the environment construction information to deploy the image on a host as a container.

8. An environment construction support method for a system including an environment construction support unit and a know-how accumulation unit, the method comprising:
on reception of an environment construction request with fragmentary environment construction information from a request source,
the environment construction support unit acquiring know-how information from the know-how accumulation unit that accumulates know-how information about environment construction for an image that is a source of a container; and
the environment construction support unit complementing, based on the know-how information, the fragmentary environment construction information to generate completed environment construction information.

9. (canceled)

10. A non-transitory computer-readable medium storing therein a program causing a processor to perform processing comprising:
on reception of an environment construction request with the fragmentary environment construction information from a request source, transmitting a know-how information request to a know-how accumulation unit that accumulates know-how information about environment construction for an image that is a source of a container, in order to acquire know-how information for complementing fragmentary environment construction information; and
on reception of the know-how information that matches the fragmentary environment construction information in response to the know-how information request, complementing, based on the know-how information, the fragmentary environment construction information, based on the know-how information to generate completed environment construction information.

11. The environment construction support system according to claim 1, wherein the know-how accumulation unit and the environment construction support unit are arranged as separate units communicating to each other via a network.

12. The environment construction support system according to claim 1, wherein the know-how accumulation unit and the environment construction support unit are integrated in a single unit wherein the know-how accumulation unit and the environment construction support unit are implemented as virtual machines to communicate to each other via a virtual network and the storage unit is implemented as a virtual storage.

13. The environment construction support method according to claim 8, comprising:
on reception of the fragmentary environment construction information, the environment construction support unit transmitting a know-how information request to the know-how accumulation unit, in order to acquire know-how information to complement the fragmentary environment construction information;
on reception of the know-how information request, the know how accumulation unit searching to find whether or not the know-how information that matches the fragmentary environment construction information is registered in the storage apparatus;
the environment construction support unit receiving the know-how information from the know how accumulation unit, in a case where the know how information that matches the fragmentary environment construction information is registered; and
the environment construction support unit complementing the fragmentary environment construction information to generate the completed environment construction information, based on the know-how information received.

14. The environment construction support method according to claim 8, comprising:
the environment construction support unit requesting the know-how accumulation unit to search to find whether or not know-how information that matches partially the fragmentary environment construction information is stored in the storage apparatus, when know-how information regarding image that matches the fragmentary environment construction information is not acquired; and
the environment construction support unit transmitting the know-how information that partially matches the fragmentary environment construction information to a source of the environment construction request, when the know-how information that partially matches the fragmentary environment construction information is returned from the know-how accumulation unit.

15. The environment construction support method according to claim 8, wherein the fragmentary environment construction information includes
priority information that specifies which item is prioritized among the know-how information, the method further comprising
the environment construction support unit selecting any one from a plurality of items of the know-how information returned from the know-how accumulation unit, based on the priority information, in case where in the know-how accumulation unit has the plurality of items of the know-how information that match the fragmentary environment construction information registered in the know-how accumulation unit.

16. The environment construction support method according to claim 15, comprising:
the environment construction support unit requesting the request source to add priority information, when superiority or inferiority of the know-how information cannot be determined based on the priority information of the fragmentary environment construction information.

17. The environment construction support method according to claim 8, wherein the know-how information registered in the know-how accumulation unit includes, for a target individual image, at least any one of:
a version number of the target image;
configuration and specification of one or more resources assigned to the target image;
an image and a version number thereof, operation confirmed with a configuration combined with the target image;
a host with the target image deployed thereon; and
performance of processing of the target image.

18. The environment construction support method according to claim 8, comprising:
the environment construction support unit delivering the completed environment construction information to an orchestrator; and
the orchestrator acquiring a corresponding image from public repository that accumulate images according to the environment construction information to deploy the image on a host as a container.

19. The non-transitory computer-readable medium according to claim 10, storing the program causing the processor to perform processing comprising:
on reception of the fragmentary environment construction information, transmitting a know-how information request to the know-how accumulation unit, in order to acquire know-how information to complement the fragmentary environment construction information,
on reception of the know-how information request from the environment construction support unit, the know how accumulation unit searching to find whether or not the know-how information that matches the fragmentary environment construction information is registered in the storage apparatus,
receiving the know-how information from the know how accumulation unit, in a case where the know how information that matches the fragmentary environment construction information is registered, and wherein
complementing the fragmentary environment construction information to generate the completed environment construction information, based on the know-how information received.

20. The non-transitory computer-readable medium according to claim 10, storing the program causing the processor to perform processing comprising:
requesting the know-how accumulation unit to search to find whether or not know-how information that matches partially the fragmentary environment construction information is stored in the storage apparatus, when know-how information regarding image that matches the fragmentary environment construction information is not acquired; and
transmitting the know-how information that partially matches the fragmentary environment construction information to a source of the environment construction request, when the know-how information that partially matches the fragmentary environment construction information is returned from the know-how accumulation unit.

21. The non-transitory computer-readable medium according to claim 10, wherein the fragmentary environment construction information includes
priority information that specifies which item is prioritized among the know-how information, and
wherein the processing performed by the processor includes
selecting any one from a plurality of items of the know-how information returned from the know-how accumulation unit, based on the priority information, in case where in the know-how accumulation unit has the plurality of items of the know-how information that match the fragmentary environment construction information registered in the storage apparatus.
